(19) United States
(12) Patent Application Publication
(10) Pub. No.: US 2009/0001777 A1
(43) Pub. Date: Jan. 1, 2009

(54) Vehicle Seat with a Ventilation Device

(75) Inventors: Claudio Bargheer, Holzgerlingen (DE); Karl Pfahler, Stuttgart (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 11/883,058

(22) PCT Filed: Dec. 20, 2005
(86) PCT No.: PCT/EP2005/013723

§ 371 Date: Jun. 11, 2008

(30) Foreign Application Priority Data
Jan. 27, 2005 (DE) 10 2005 003 866.2

(51) Int. Cl. B60N 2/56

(52) U.S. Cl. 297/180.1

(57) ABSTRACT

A vehicle seat has a fan device embedded in a ventilation layer as a radial fan. Fresh air is taken in from the end side of the vehicle seat.

### CROSS REFERENCE TO RELATED APPLICATIONS

This application is a national stage PCT International Application No. PCT/EP2005/013723, filed Dec. 20, 2005, which claims priority under 35 U.S.C. §119 to German Application No. 10 2005 003 866.2 filed Jan. 27, 2005, the entire disclosures of which are herein expressly incorporated by reference.

### BACKGROUND AND SUMMARY OF THE INVENTION

The present invention relates to a vehicle seat with a ventilation device.

It is sufficiently known from the prior art to provide vehicle seats with heating means and ventilation devices in order to increase the comfort for the vehicle occupants.

For example, it is known to conduct hot air through a vehicle seat, in particular the backrest, in order to control the temperature of that region of the vehicle seat with which the vehicle occupant is in contact, in accordance with the requirements desired by said vehicle occupant.

For this purpose, air is sucked up generally from the rear side of the vehicle seat by means of a fan and pressed into the seat via air passages and air-guiding layers provided in the vehicle seat and/or the backrest. A device of this type is known, for example, from German Patent DE 103 19 148 B3.

In this device, a fan sucks up air through an air-guiding layer and air passages through openings which are located at the upper edge and at the lower edge of the rear side of the backrest.

In the region behind the vehicle seat there is often stationary hot air which arises, for example, because of the hot front partition next to the rear seats. In the case of the previously described device, the hot air is sucked up by the fan. Depending on the temperature of the stationary air, the desired ventilation effect does not occur at all or only at a later point. A complicated technique therefore has to be used for mixing of cold and hot air to take place, which reduces the effectiveness of the ventilation.

Proceeding therefrom, it is an object of the present invention to provide a more effective ventilation of a vehicle seat.

This object is achieved by the features of patent claim 1.

This and other objects and advantages are achieved by exemplary embodiments of the present invention in which a radial fan directly integrated in the ventilation layer of the vehicle seat, with the air suction opening for the radial fan opening into the end surface of the vehicle seat (i.e. the surface which faces the vehicle occupant), with the air suction opening being located essentially outside a contact region with the seated person (i.e. essentially at the lateral edges of the vehicle seat).

A device of this type for ventilating the vehicle seat can be used both for the backrest region and for the seat cushion region of the vehicle seat.

Ideally, the air outlet opening of the ventilation layer is located in the respectively opposite surface, i.e., either on the lower side of the seat surface or on the rear side of the backrest.

The solution according to the invention turns out to be particularly cost-effective, since extra air passages or further openings do not have to be provided in the backrest tensioning part. Furthermore, the design of the vehicle seat is not impaired by such an arrangement which can be used both for the seat region and for the backrest region.

The air-conditioning comfort of the vehicle seat is substantially increased, since, via the vehicle seat cover, fresh air on the front side can be guided directly and rapidly into the particular regions of the vehicle seat.

Owing to the use of a radial fan directly in the ventilation layer, the direct deflection of the air at the radial fan and the end-side feeding of the ventilation air into the ventilation layer make it possible to avoid unnecessary losses, and therefore the operation can be carried out with greater ventilation efficiency. This in turn means fewer fan devices or a smaller fan being necessary in order to obtain the same ventilation effect.

The invention will now be explained in more detail with reference to the exemplary embodiment which is illustrated in the attached drawing, in which:

### BRIEF DESCRIPTION OF THE DRAWINGS

The single FIGURE shows, schematically in cross section, a surface of a vehicle seat.

### DETAILED DESCRIPTION OF THE DRAWINGS

Referring to the FIGURE, the reference number 1 illustrates, in cross section, either the seat cushion region or the backrest region of a vehicle seat, which 1 includes a basic body 2, an upholstery or a spring core with, for example, a sheet-metal shell as the abutment which is covered by a seat cover 3. A vehicle occupant S is sitting or leaning on or against the end surface 4, i.e. either on a seat surface or against a backrest surface. An air suction opening 5 is located in the region which is left free in the end surface 4 by the vehicle occupant S, as a rule in the lateral edges of the vehicle seat.

If appropriate, an air-permeable nonwoven or a perforated foam insert with integrated heating elements follows below the seat cover 3.

Between said layer 6 and the basic body 2 there is a ventilation layer 7 which is constructed from a rubber knit, rubberized hair or the like. A rubber knit or similar is likewise provided in the region of the air suction opening 5 which is likewise spanned by the seat cover 3 which is of air-permeable configuration at this point. A radial fan 8 is arranged below the air suction opening 5 and within the ventilation layer 7.

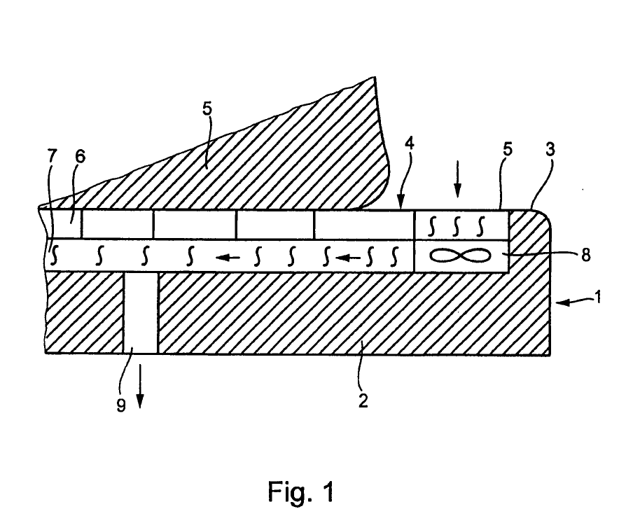

As can be seen with reference to the arrows illustrated in FIG. 1, the radial fan 8 sucks up air on the front side via the air suction opening 5 and conducts the sucked-up fresh air through the ventilation layer 7 to an air outlet opening 9 which opens into that surface of the section 1 of the vehicle seat that lies opposite the end surface 4.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-3. (canceled)

4. A vehicle seat with at least one fan device connected to at least one ventilation layer, which is integrated in the vehicle seat, in order to ventilate the vehicle seat, wherein the at least one fan device is embedded in the at least one ventilation layer as a radial fan and an air suction opening of the radial fan opens into an end surface of the vehicle seat which faces a seated person at a point substantially outside a contact region of the seated person with said end surface.

5. The vehicle seat as claimed in claim 4, wherein the end surface is at least one of a seat surface and a backrest surface of the vehicle seat.

6. The vehicle seat as claimed in claim 4, wherein an air outlet opening of the ventilation layer opens into a surface lying opposite the end surface.

7. The vehicle seat as claimed in claim 5, wherein an air outlet opening of the ventilation layer opens into a surface lying opposite the end surface.

8. A vehicle seat comprising:
a ventilation layer integrated into the vehicle seat; and
a fan device connected to the ventilation layer to ventilate the vehicle seat, the fan device embedded in the ventilation layer as a radial fan;
wherein an air suction opening of the radial fan opens into an end surface of the vehicle seat which faces a seated person at a point substantially outside a contact region of the seated person with said end surface.

9. The vehicle seat as claimed in claim 8, wherein the end surface is at least one of a seat surface and a backrest surface of the vehicle seat.

10. The vehicle seat as claimed in claim 8, wherein an air outlet opening of the ventilation layer opens into a surface lying opposite the end surface.

11. The vehicle seat as claimed in claim 9, wherein an air outlet opening of the ventilation layer opens into a surface lying opposite the end surface.
